(19) United States
(12) Patent Application Publication
(10) Pub. No.: US 2026/0110387 A1
(43) Pub. Date: Apr. 23, 2026

(54) MULTIPIECE INFLATABLE PLUG SYSTEM

(71) Applicant: Nathan Weston, Bonita Springs, FL (US)

(72) Inventor: Nathan Weston, Bonita Springs, FL (US)

(21) Appl. No.: 18/920,480

(22) Filed: Oct. 18, 2024

(51) Int. Cl. F16L 55/134

(52) U.S. Cl. CPC F16L 55/134

(57) ABSTRACT

Inflatable pipe plug systems are described.

### FIELD

Some implementations relate generally to plumbing test plugs for diagnostic testing of plumbing systems, and, more particularly, to multipiece inflatable plug systems.

### BACKGROUND

Conventional inflatable plugs, such as that shown in FIG. 1, typically have a single piece inflatable air bladder 102 that can be inflated through a typical tire air valve 105 via a hose 103 (and an optional extension hose) to cause the air bladder to expand within a pipe and temporarily plug the pipe. Such plugs can be useful as a tool to help with diagnostic testing of plumbing systems. For example, pressure testing and detecting leaks in swimming pool plumbing, etc.

A limitation of some conventional inflatable plugs is that the single piece air bladder may rupture under repeated cycles of inflation/deflation as shown in FIG. 2. Once the air bladder 102 develops a leak 104, the entire tool must be discarded and replaced.

A need may exist for an inflatable plug system that can be repaired by easily replacing the inflatable bladder portion and thus help reduce expense, down time, and/or additional service call trips when diagnosing plumbing systems such as performing pressure testing and leak detection on swimming pool plumbing.

Embodiments were conceived in light of the above-mentioned problems and limitations, among other things. The background description provided herein is for the purpose of generally presenting the context of the disclosure. Work of the presently named inventor, to the extent it is described in this background section, as well as aspects of the description that may not otherwise qualify as prior art at the time of filing, are neither expressly nor impliedly admitted as prior art against the present disclosure.

### BRIEF DESCRIPTION OF THE DRAWINGS

FIG. 1 is a diagram showing an example prior art inflatable plug with extension hose and air valve.

FIG. 2 is a diagram showing an example prior art inflatable plug failing by a rupture.

FIG. 3 is a diagram showing an exploded view of an example multipiece inflatable plug in accordance with some implementations.

FIG. 4 is a diagram showing an assembled view of an example multipiece inflatable plug in accordance with some implementations.

FIG. 5 is a diagram showing an example inflatable plug that has been inflated within a pipe in accordance with some implementations.

FIG. 6 is a diagram showing an example inflatable plug that has been inserted into and past a small diameter rotatable eye return jet of a swimming pool in accordance with some implementations.

FIG. 7 is a diagram showing an example inflatable plug that has been inserted into a small diameter rotatable eye return jet of a swimming pool and inflated in accordance with some implementations.

FIG. 8 is a diagram showing an example inflatable plug having an air hose with a bendable member internal to the air hose in accordance with some implementations.

FIGS. 9A, 9B, and 9C are a series of diagrams showing examples of an inflatable plug having an inflatable bladder with a bendable member internal to the air hose and extending into the bladder secured into the far end cap in accordance with some implementations.

FIGS. 10A, 10B, and 10C are a series of diagrams showing examples of an inflatable plug having an inflatable bladder with a bendable member internal to the air hose and extending into the bladder through a barbed hose fitting in accordance with some implementations.

FIGS. 11A,11B, 11C are a series of diagrams showing examples of an inflatable plug having an inflatable bladder with a bendable member internal to the air hose and extending into the bladder through a “push to connect fitting” in accordance with some implementations.

FIG. 12 is a of diagrams showing an example inflatable plug deploying a stent to repair a leak in a pipe in accordance with some implementations.

FIG. 13A is a diagram of an example flexible sheath or sleeve protecting the inflatable plug from adhesives during stent deployment in accordance with some implementations.

FIG. 13B is a detailed view of the non-slip surface texture of the flexible sheath in accordance with some implementations.

FIG. 13C is an assembled view of a stint installed over a flexible sheath in accordance with some implementations.

FIG. 14A is a diagram of a cut away view of an example inflatable plug having an inflatable bladder with a single end cap in accordance with some implementations.

FIG. 14B is a picture of an example inflatable plug having an inflatable bladder with a single end cap in accordance with some implementations.

FIG. 15 is a diagram showing an exploded view of an example inflatable plug having an interior channel in accordance with some implementations.

FIG. 16 is an exploded view of an example inflatable plug having an interior channel in accordance with some implementations.

FIG. 17 is a cut away diagram of an inflatable plug showing the interior channel accordance with some implementations.

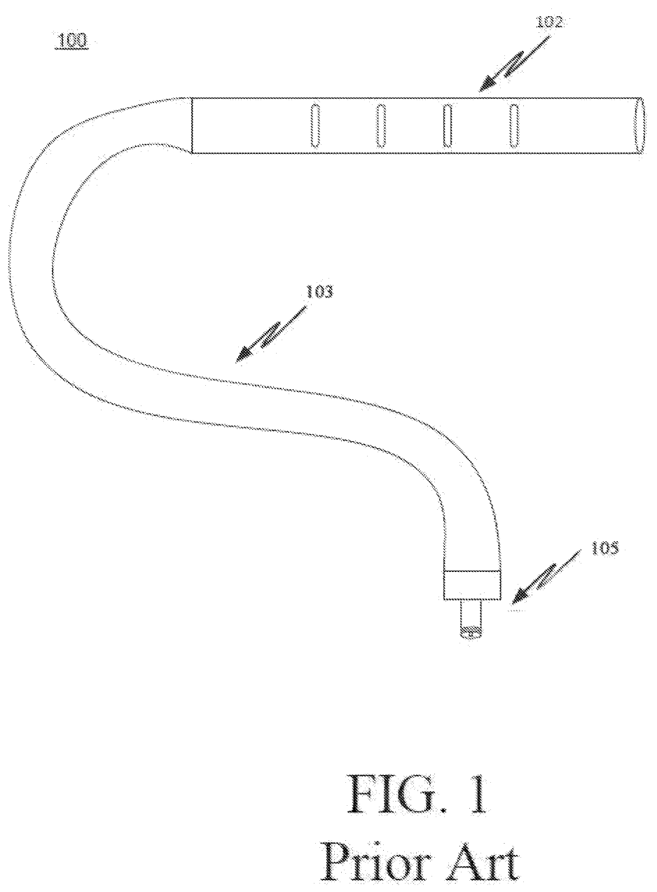

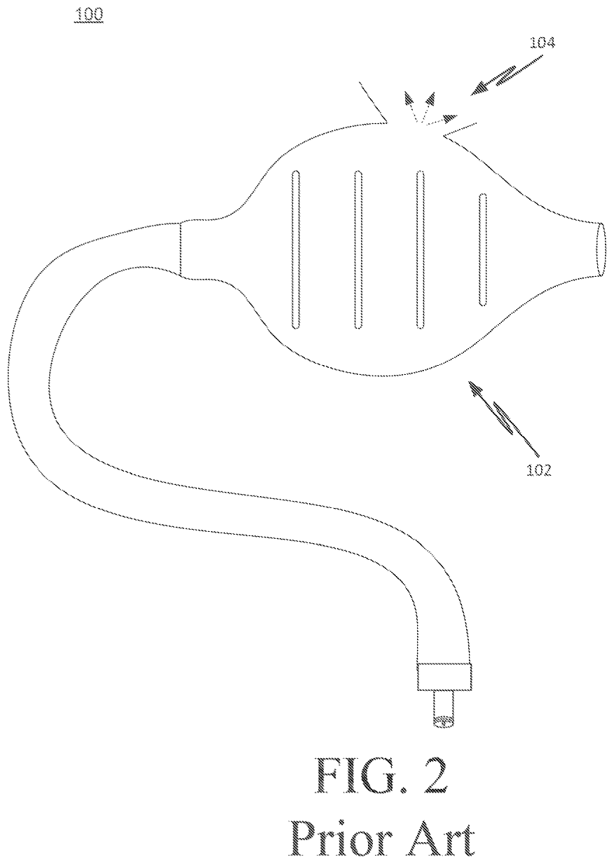

### DETAILED DESCRIPTION

It will be appreciated that swimming pool plumbing is described herein as an example to illustrate the principles of the disclosed subject matter, the disclosed subject matter and implementations thereof are not limited to plumbing for swimming pools and can be used in any application where an inflatable plug may be useful to temporarily block a pipe or other passage from the flow of fluid or other materials.

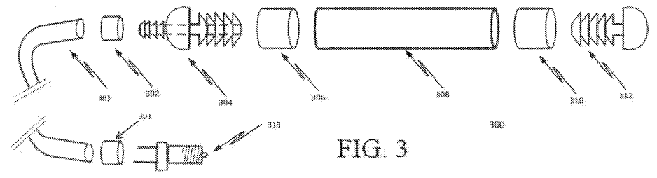

FIG. 3 is a diagram showing an exploded view of an example inflatable plug 300 in accordance with some implementations. The inflatable plug 300 includes an inflation hose 303, first air hose crimp ring 301, a second air hose crimp ring 302, a first end cap 304, a first bladder crimp ring 306, a bladder section 308, a second bladder crimp ring 310, a second end cap 312 and an inflation air valve 313.

In operation, the bladder 308 can be a section of tube made of a synthetic or natural elastomeric material that is configured to be inflated or deflated. A key feature of the inflatable plug 300 is that the bladder 308 is replaceable. For example, if the bladder 308 bursts during use, the first end cap 304 and the second end cap 312 can be removed by disassembling the first and second crimp rings 306/310. A new bladder 308 (e.g., a section of tube) can be replaced by inserting the new bladder section into the first and second bladder crimp rings 306/310 and then inserting the first and second end caps 304/312 and securing them in place with the new bladder crimp rings.

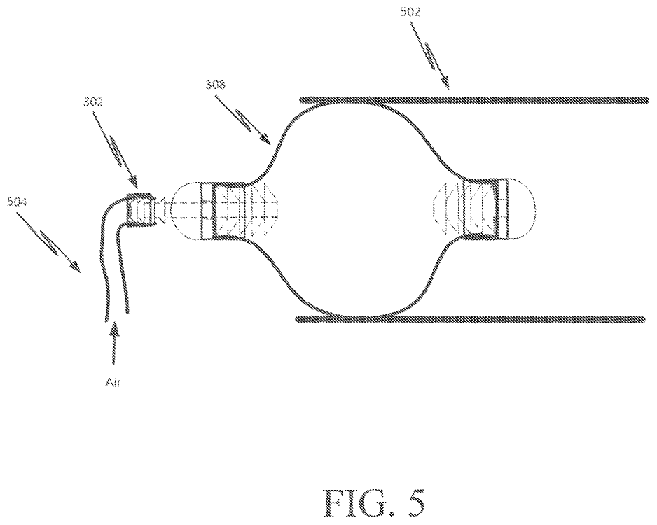

The first end cap 304 includes an air hose connector disposed at a first end of the first end cap 304 and having a bladder insertion element disposed at a second end of the first end cap 304, the first end cap 304 having a channel to communicate air from outside the air hose connection to an interior of the bladder. The air hose is secured to the air hose connector end of 304 with the second air hose crimp ring 302. The first end cap 304 is used to connect an air hose 303 to the inflatable bladder (e.g., as shown in FIG. 5). Air can be supplied via a manual or electric air pump (or other source of air) through a common tire air valve 313.

The bladder crimp rings can be a swage fitting, PEX crimp ring, or any suitable type of device to provide force to secure a tube to an element inserted into the tube. Other types of connectors can include but are not limited to worm gear hose clamp, split ring clamp, ear crimp rings, cinch crimp rings, wire tension clamp, or band tension clamp or the like.

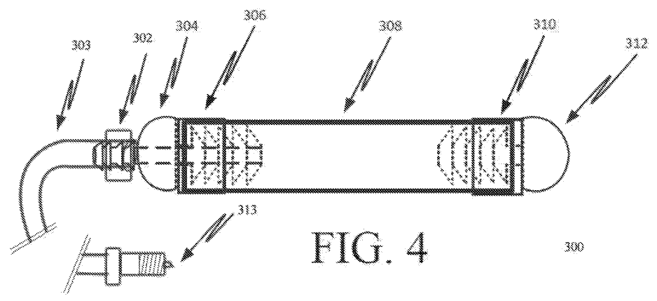

FIG. 4 is a diagram showing an assembled view of an example inflatable plug 300 with the elements described in FIG. 3.

FIG. 5 is a diagram showing an example inflatable plug 300 in which the bladder 308 has been inflated within a pipe 502 via air from an inflation hose 504 connected to the inflatable bladder 300.

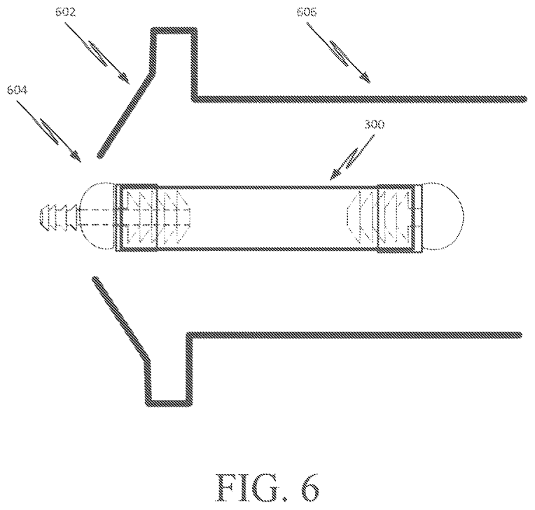

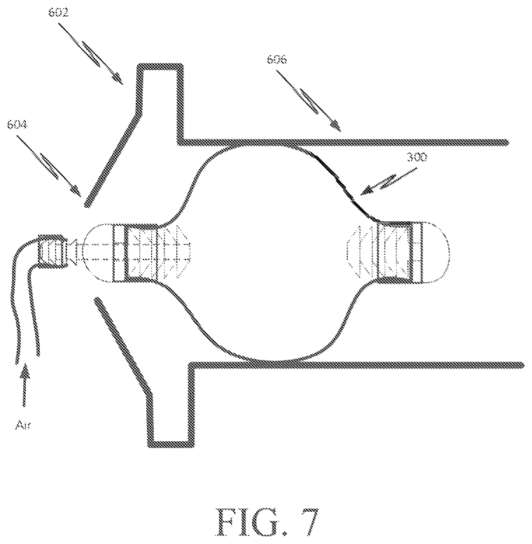

FIG. 6 is a diagram showing an example inflatable plug 300 that has been inserted into a rotatable eyeball return jet 602 of a swimming pool in accordance with some implementations. An advantage of the inflatable plug 300 described herein is that it can be inserted into an aperture or eye 604 having a diameter smaller than a pipe 606 to be plugged. In FIG. 7, the inflatable bladder 308 has positioned past the smaller eyeball and has been inflated to plug the pipe 606.

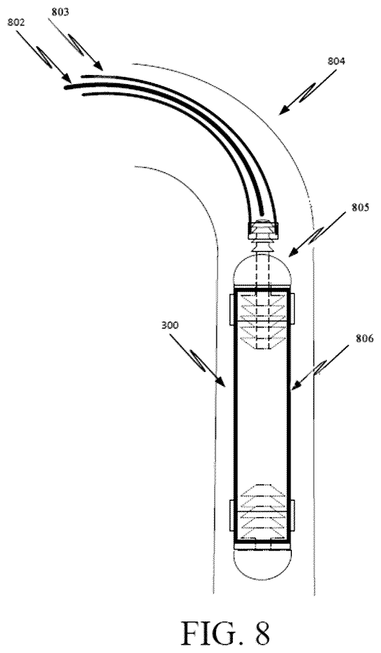

FIG. 8 is a diagram showing an example inflatable plug having an inflation hose 803 with a bendable member 802 in accordance with some implementations. The bendable member 802 can be formed from a bendable metal wire such as aluminum, copper, or other metal or alloy having a characteristic of being able to be bent into a shape and then holding that shape until being bent into another shape. In this embodiment the bendable metal wire stops at the first end cap with aperture 805 where in other embodiments it will pass through the end cap with aperture into the inflatable bladder secured to the second end cap with some other implements.

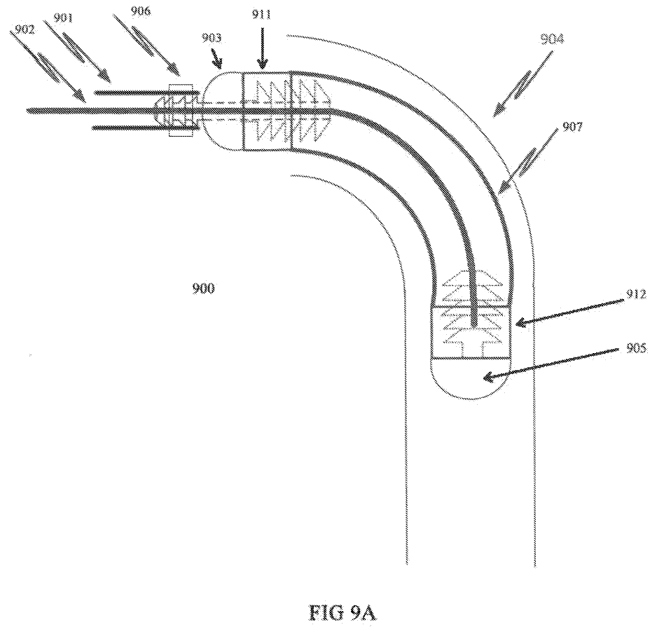

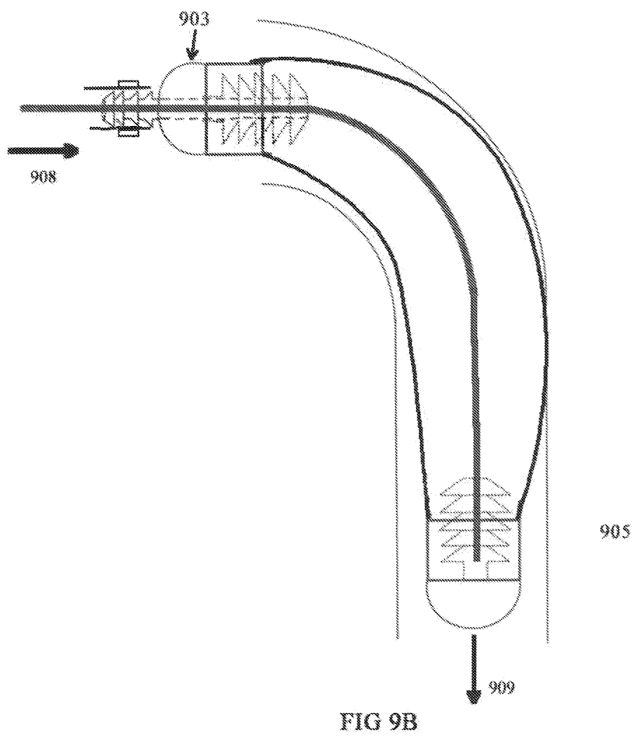

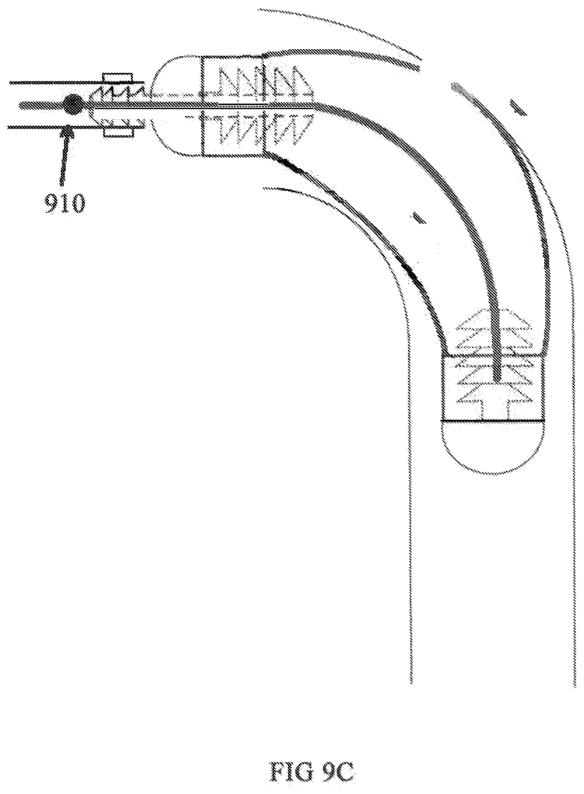

FIGS. 9A, 9B, 9C are diagrams showing another embodiment of a multipiece inflatable plug 900 having an inflatable bladder 907 with a bendable wire member 902 in accordance with some implementations. The bendable member 902 can be formed from a bendable metal wire such as aluminum, copper, or other metal or alloy having a characteristic of being able to be bent into a shape and then holding that shape until being bent into another shape. This bendable wire passes freely through the first end cap with aperture 903, passes through the inflatable bladder 907, and terminates in a secured position in the second end cap 905. This bendable wire forces conformity of rubber bladder 907 into desired shape along the path of the bendable member for easier insertion and navigation around bends in the pipe.

FIG. 9B shows the result of inflation of plug 900 where the bendable wire member is secured in second end cap 905 but still allowed to pass freely through the aperture in the first end cap 903. The elongation and travel 909 of the inflatable bladder is not restricted as it is inflated because the bendable wire is free to move along the path 908 through the aperture of the first end cap 903.

FIG. 9C is a variation of inflatable plug 900 where the bendable wire has a stop 910 located before the first end cap restricting the wires travel through the first end cap aperture and disallowing the elongation of rubber bladder during inflation and expansion. This wire stop 910 can take the form of a crimp, swage or a kink in the wire or any other item that restricts its passage through the aperture. This configuration allows the inflatable bladder to remain at constant length during inflation and still conform to the pre-bent shape of the wire member.

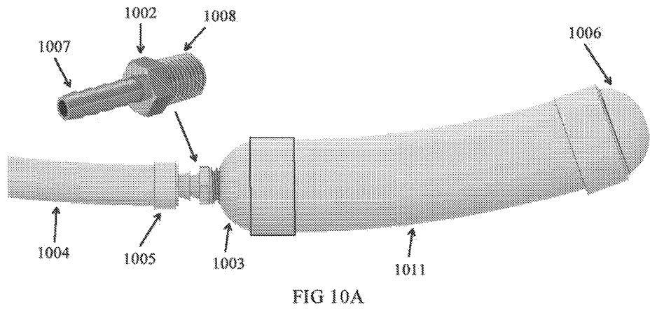

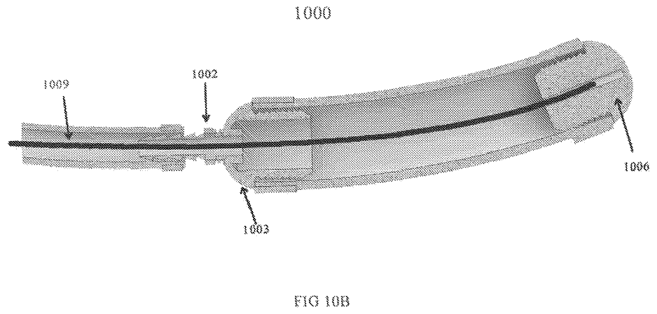

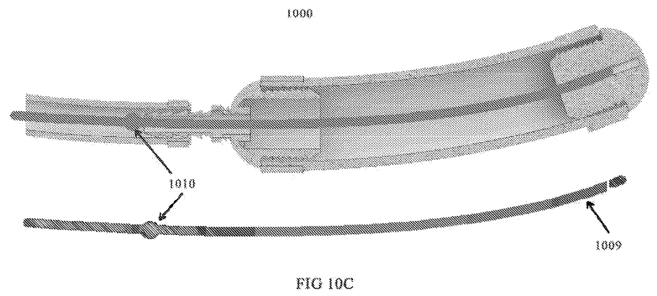

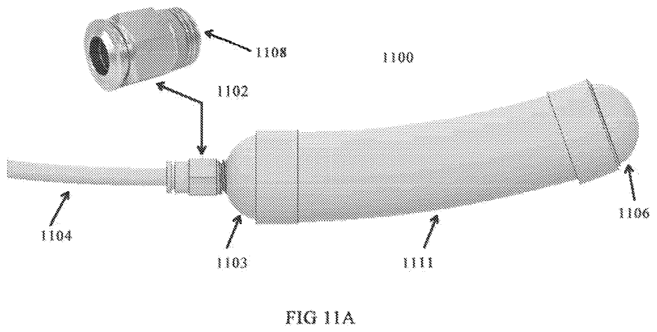

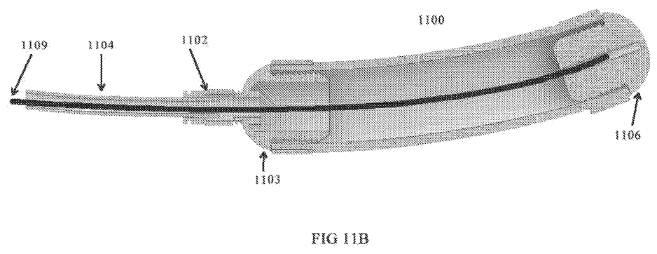

FIG. 10A is an embodiment of a multipiece inflatable plug 1000 with the air hose connection of the first end cap 1003 made by a barbed air hose connector 1002 to attach the air hose 1004 to the first end cap. On one end, these barbed hose connectors have a series of ridges 1007 pointing one direction that allows an inflation hose to be pressed on the barbs in one direction but locks the hose in place with the direction of the pointed barbs. This connection can be further reinforced with a hose crimp 1005. The other end of the barbed hose connector usually has threads 1008 that will conform to the threads introduced on the first end cap 1003.

FIG. 10B is a variation of inflatable plug 1000 where the bendable metal wire is projected through the apertures of both the barbed hose connector 1002 and the first end cap 1003 and is secured at the second end cap 1006. This configuration with the bendable metal wire allows the length of the inflatable to elongate as the plug is being inflated allowing the plug to retain its shape predetermined by the bendable wire member 1009.

FIG. 10C is a variation of inflatable plug 1000 where the bendable wire has a stop 1010 located before the first end cap restricting the wires travel through the first end cap aperture and disallowing the elongation of rubber bladder during inflation and expansion. This wire stop 1010 can take the form of a crimp, swage or a kink in the wire or any other item that restricts it passage through the aperture. This configuration allows the inflatable bladder to remain at constant length during inflation and still conform to the pre-bent shape of the wire member.

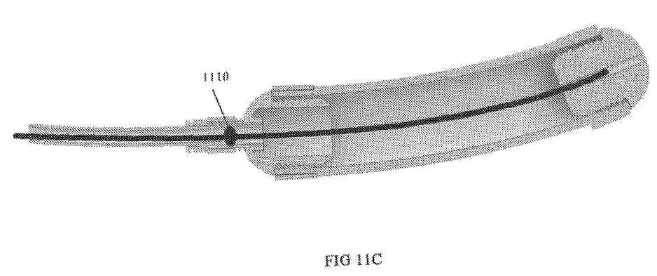

FIG. 11 is another embodiment 1100 with the air hose connection of the first end cap with aperture 1103 by a “Push Connect Fitting” hose connector 1102 to attach the air hose 1104 to the first end cap 1103. These push connect fittings feature an internal ring of teeth pointing towards the interior so the inflation hose that is pushed inside is locked in with these teeth and sealed with an O-ring around the hose's exterior. The other end of the connector is usually threaded 1108 to match corresponding threads of the first end cap with aperture 1103.

FIG. 11B is a variation of inflatable plug 1100 where the bendable metal wire 1109 is freely projected through the apertures of both the push connect fitting and the first end cap 1103 and is secured at the second end cap 1106. This configuration with the bendable metal wire allows the length of the inflatable to elongate as the plug is being inflated allowing the plug to retain its shape predetermined by the bendable wire member.

FIG. 11C is a variation of inflatable plug 1100 where the bendable wire has a stop 1110 located before the first end cap restricting the wires travel through the first end cap aperture and disallowing the elongation of rubber bladder during inflation and expansion. This wire stop 1110 can take the form of a crimp, swage or a kink in the wire or any other item that restricts it passage through the aperture. This configuration allows the inflatable bladder to remain at constant length during inflation and still conform to the pre-bent shape of the wire member.

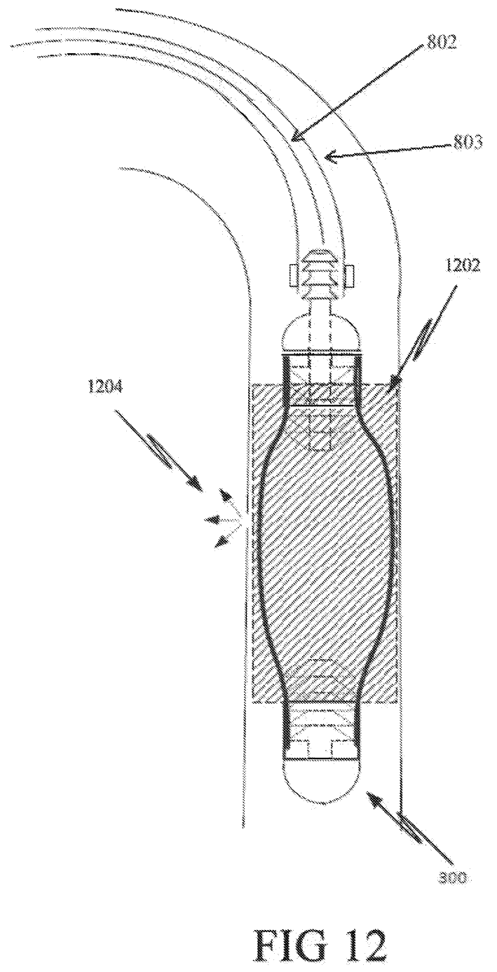

FIG. 12 is a diagram showing an example inflatable plug 300 deploying a stent 1202 to repair a leak 1204 in a pipe in accordance with some implementations. The inflatable plug can be inserted into the stent 1202 (e.g., a rubber bag, epoxy impregnated fiberglass/Kevlar woven cloth, or other type of stent) and then the plug, along with the bendable wire member 802 inside the air hose 803, is used to position the stent at a desired location in the pipe where a leak may be. The inflatable plug can then be used to expand the stent and cause the stent to repair the leak. The deploying inflatable plug can be any version of the previously mentioned plugs in FIGS. 8 through 11. When deploying a stent, the inflatable plug can be inflated with a fluid (e.g., air or water) at a temperature that can cause the stent to expand and/or be set into place. For example, heated fluid can be used to expand the inflatable plug where the heat is used to cause the stent to bend, activate or cure.

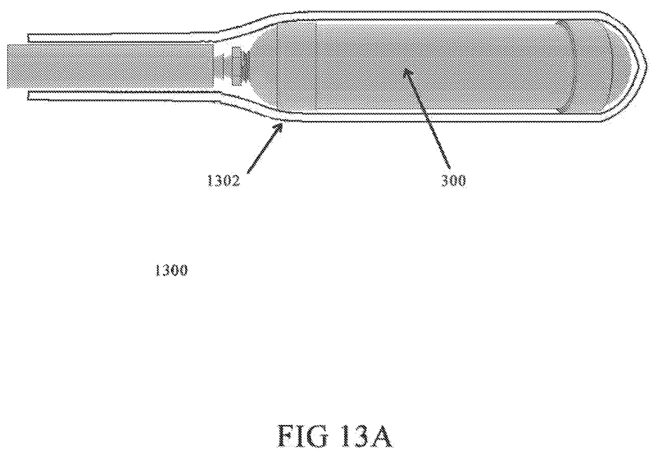

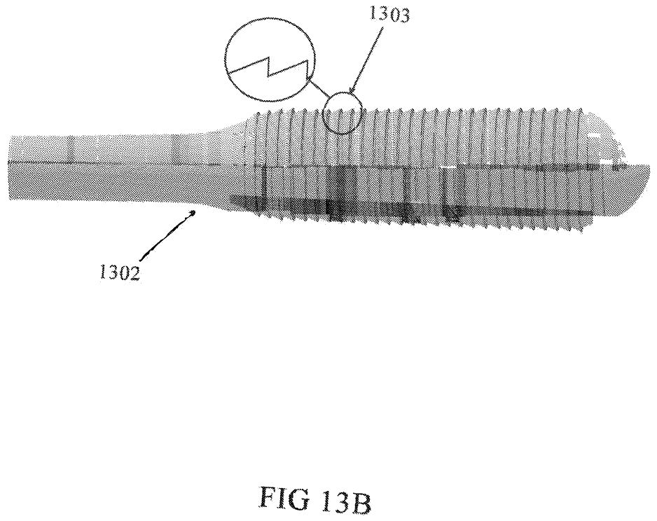

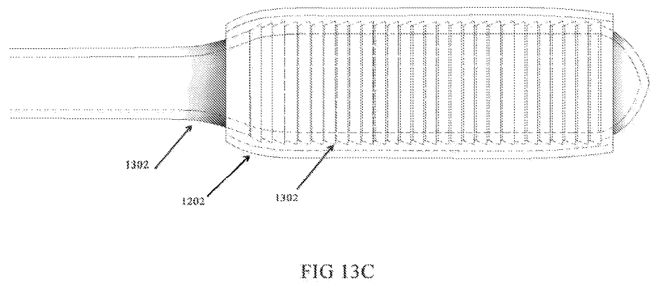

FIGS. 13A, 13B,13C are pictures of a flexible sleeve or sheath 1302 that covers the inflatable plug 300 placed underneath stint material 1202 and prevents adhesives and glues from sticking to the inflatable plug and parts. This sheath can be made from flexible and nonstick materials such as silicon rubber and the like. The sheath can also have nonslip directional patterns such as ribs 1303 suitable for positioning the stint deep into the pipe and easily removing the inflatable plug without disturbing the stint.

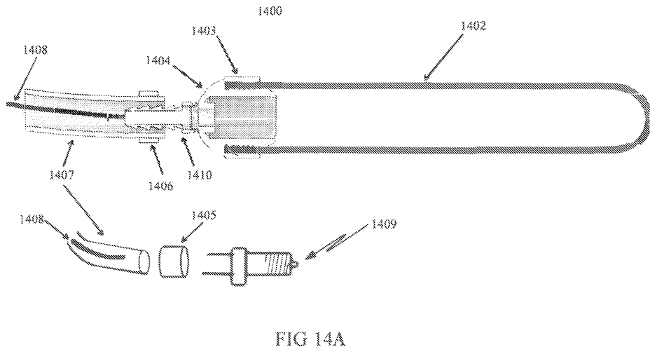

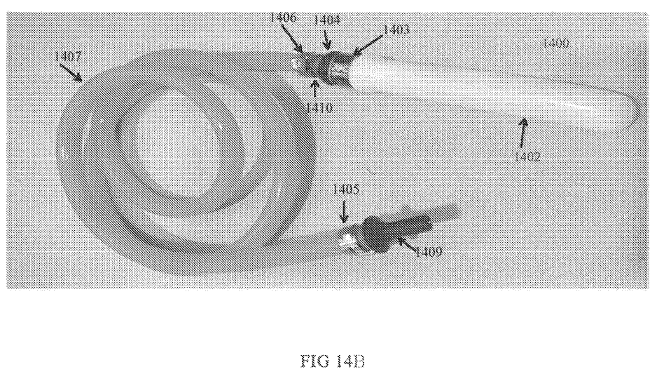

FIGS. 14A, 14B are diagrams of an example inflatable plug 1400 having an inflatable bladder with a single end cap in accordance with some implementations. The inflatable plug 1400 has just one end of the rubber bladder open and crimped with bladder crimp ring 1403 on first end cap 1404 and the other end is closed. If the inflatable bladder ruptures or develops a leak, it can be replaced by removing the bladder crimp ring 1403 or swage connector at the first end cap 1404 and replacing the inflatable bladder 1402. This embodiment can have the air hose connections of any of the FIGS. 8-11. This embodiment also has a bendable wire member 1408 placed inside air hose 1407 beginning at air inflation valve 1409 running to air hose connection 1410 at end cap 1404. The air hose is secured to air inflation valve 1409 by first air hose crimp 1405 and at the far end the air hose is secured to the air hose connector with second air hose crimp ring 1406.

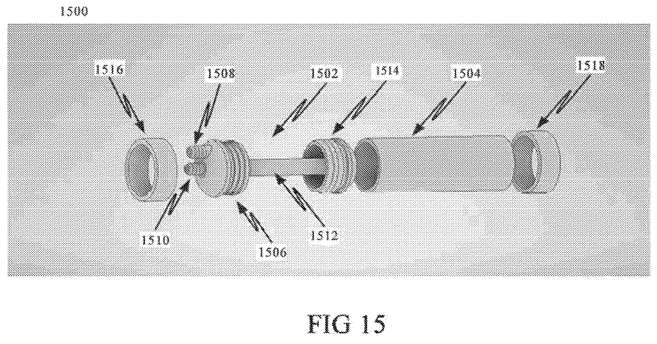

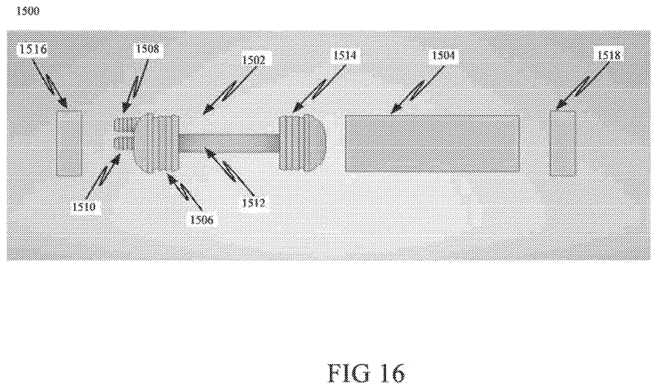

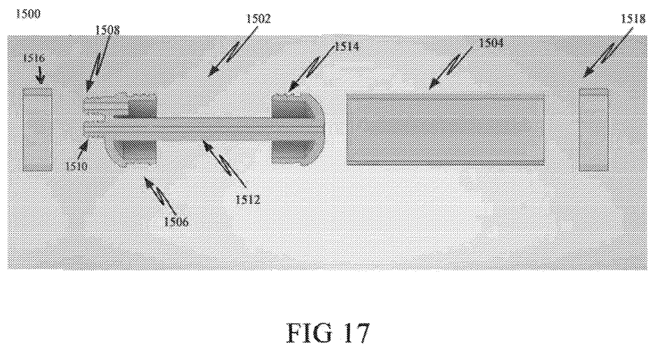

FIG. 15-17 are diagrams showing an example inflatable plug having an interior channel or tube and are referred to as an “inducer plug” in accordance with some implementations. The type of plug called an inducer plug will have 2 separate inlets 1508 and 1510. The inducer plug can have fluids pass through an interior tube out to the pipe beyond while maintaining a separate constant inflated bladder pressure holding the plug firmly in the pipe. In particular, the inflatable plug 1500 includes an interior member 1502 and an inflatable bladder 1504. The interior member 1502 includes a first end cap 1506, a first inlet 1508 to inflate the air bladder 1504, a second inlet 1510 coupled to an interior channel 1512, and a second end cap 1514. The inflatable bladder 1504 is coupled to the interior member 1502 at the first end cap via first bladder crimp ring or swage connector 1516 and at a second end cap 1514 via a second bladder crimp ring or swage connector 1518.

In operation, the inflatable bladder 1504 can be inflated via the first inlet 1508 to plug a pipe. Then, a fluid (e.g., air or liquid) can be passed into the plugged pipe via the second inlet 1510 through channel 1512.

While some example implementations have been described in terms of a general embodiment with several specific example modifications, it is recognized that other modifications and variations of the embodiments described above are within the spirit and scope of the disclosed subject matter. Applicant intends to embrace any and all such modifications, variations and embodiments.

What is claimed is:

1. An inflatable pipe plug system comprising:
a bladder section that is configured to be inflated or deflated, wherein the bladder section is replaceable;
a first end cap having an air hose connector disposed at a first end of the first end cap and having a bladder insertion element disposed at a second end of the first end cap, the first end cap having a channel to communicate air from outside the air hose connector to an interior of the bladder, wherein the first end cap is configured to be inserted into a first end of the bladder and secured in place via a first crimp ring; and
a second end cap having a second end bladder insertion element that is configured to be inserted into a second end of the bladder section and secured in place with a second crimp ring.

2. The inflatable pipe plug system of claim 1, wherein the bladder section is formed from a tubular section of an elastomeric material.

3. The inflatable pipe plug system of claim 1, further comprising an air hose having a first end configured to be secured to the air hose connector via a first air hose crimp ring and having a second end with an air source connection secured with a second air hose crimp ring.

4. The inflatable pipe plug system of claim 1, wherein the first crimp ring and the second crimp are each one of a swage fitting or a PEX crimp ring.

5. The inflatable pipe plug system of claim 3, wherein the first air hose crimp ring is a swage fitting or a PEX crimp ring.

6. The inflatable pipe plug system of claim 1, wherein the first crimp ring and the second crimp ring are each one of a worm gear hose clamp, ear cinch ring, crimp pinch ring, split ring clamp, wire tension clamp, or band tension clamp.

7. The inflatable pipe plug system of claim 3, wherein the second air hose crimp ring is one of a worm gear hose clamp, split ring clamp, wire tension clamp, or band tension clamp.

8. The inflatable pipe plug system of claim 1, wherein the air hose includes a bendable member disposed within an interior channel of the air hose, wherein the bendable member, when bent into a given shape, is constructed to retain that shape, and wherein the bendable member includes a stop that prevents the bendable member from being inserted into the bladder section more than a given distance.

9. An inflatable pipe plug system comprising:
a bladder section that is configured to be inflated or deflated, wherein the bladder section is replaceable, wherein the bladder section includes a bendable metal member that, when bent into a given shape, is constructed to retain that shape, and wherein the bendable member includes a stop that prevents the bendable member from being inserted into the bladder section more than a given distance;
a first end cap configured to be inserted into a first end of the bladder section and secured in place via a first crimp ring; and
a second end cap having an air hose connector disposed at a first end of the second end cap and having a bladder insertion element disposed at a second end of the second end cap, the second cap having a channel to communicate air from outside the air hose connection to an interior of the bladder section,
wherein the bladder insertion element is configured to be inserted into a second end of the bladder section and secured in place with a second crimp ring.

10. The inflatable pipe plug system of claim 9, further comprising an air hose having a first end configured to be secured to the air hose connector via an air hose crimp ring and having a second end with an air source connection.

11. The inflatable pipe plug system of claim 9, wherein the first crimp ring and the second crimp are each one of a swage fitting or a PEX crimp ring.

12. The inflatable pipe plug system of claim 9, wherein the bladder is formed from a tubular section of an elastomeric material.

13. The inflatable pipe plug system of claim 10, wherein the air hose crimp ring is one of a swage fitting or a PEX crimp ring.

14. The inflatable pipe plug system of claim 9, wherein the first crimp ring and the second crimp are one of a worm gear hose clamp, ear cinch ring, crimp pinch ring, split ring clamp, wire tension clamp, or band tension clamp.

15. The inflatable pipe plug system of claim 9, wherein the third crimp ring is one of a worm gear hose clamp, ear cinch ring, crimp pinch ring, split ring clamp, wire tension clamp, or band tension clamp.

16. An inflatable pipe plug system comprising:
a bladder section that is configured to be inflated or deflated, wherein the bladder is replaceable; and
an end cap having an air hose connector disposed at a first end of the end cap and having a bladder insertion element disposed at a second end of the end cap, the end cap having a channel to communicate air from outside the air hose connection to an interior of the bladder.

17. The inflatable pipe plug system of claim 16, further comprising a second connector on the end cap coupled to a channel through the inflatable pipe plug system, where the channel is configured to communicate a fluid through the inflatable pipe plug system.
